(19) United States
(12) Patent Application Publication
(10) Pub. No.: US 2017/0297237 A1
(43) Pub. Date: Oct. 19, 2017

(54) REFRIGERATOR DISPENSER LEVER AND METHOD FOR MANUFACTURING THE SAME

(71) Applicant: DONGBU DAEWOO ELECTRONICS CORPORATION, Seoul (KR)

(72) Inventor: Sung Hwan LEE, Seoul (KR)

(21) Appl. No.: 15/365,518

(22) Filed: Nov. 30, 2016

(30) Foreign Application Priority Data
Apr. 19, 2016 (KR) 10-2016-0047749

(51) Int. Cl. B29C 45/14; B29C 45/40; B67D 1/00; B29C 51/00; B32B 7/12; B32B 15/04; B32B 27/06; F25C 5/00; B29C 51/10; B29L 31/00; B29K 55/02

(52) U.S. Cl. CPC B29C 45/14336; F25C 5/005; B29C 45/40; B67D 1/0003; B29C 51/002; B29C 51/10; B32B 7/12; B32B 15/04; B32B 27/06; B29K 2055/02; B29L 2031/7622; B29K 2995/0029; B29K 2995/0025; B32B 2509/10; B32B 2307/412; B32B 2307/414; B32B 2355/02; B29K 2995/0026

(57) ABSTRACT

Embodiments of the present disclosure provide a refrigerator dispenser lever and a method for manufacturing the same. The lever is capable of reducing post-process activity required to assemble the components, enhancing a sense of unity between components and improving the quality and appearance of the lever by combining individual components during manufacturing using a single injection molding process.

### CROSS-REFERENCE TO RELATED APPLICATION

This application is based on and claims priority from Korean Patent Application No. 10-2016-0047749, filed on. Apr. 19, 2016, the disclosure of which is incorporated herein in its entirety by reference.

### TECHNICAL FIELD

The present disclosure generally relates to refrigerators, and more specifically, to a dispenser lever for a refrigerator and a method for manufacturing the same.

### BACKGROUND

A refrigerator is an apparatus used to store food at a low temperature, for example, in a frozen state or a refrigerated state.

The interior of the refrigerator is cooled by a continuous supply of cold air. The cold air is continuously generated by a heat exchange process using a refrigerant, where a freezing cycle consisting of compression, condensation, expansion and evaporation is used to generate cold air. The cold air supplied into the refrigerator is uniformly transferred to the interior of the refrigerator by convection and is used to store food at a desired temperature within the refrigerator.

The refrigerator includes a main body having a rectangular shape and an opening on a front surface thereof. A refrigeration compartment and a freezer compartment may be provided within the main body. A refrigeration compartment door and a freezer compartment door may be provided on the front surface of the main body for selectively closing open portions of the main body. Drawers, shelves, storage compartments and the like may be provided in the internal storage spaces of the refrigerator for storing different kinds of food in an optimal state.

Top-mount refrigerators having a freezing compartment positioned above a refrigeration compartment are a common type of refrigerator. In recent years, however, bottom-freeze refrigerators having a freezing compartment positioned below a refrigeration compartment have become popular due to enhanced user convenience.

For the bottom-freeze refrigerators, the frequently-used refrigeration compartment is positioned above the less-frequently-used freezer compartment. This enables a user to conveniently use the frequently-used refrigeration compartment. However, for bottom-freeze refrigerators, the freezer compartment is positioned below the refrigeration compartment. Thus, the bottom-freeze refrigerators are somewhat inconvenient to use because the user must squat or bend over to open the freezer compartment door when retrieving ice, for example.

In order to solve this problem, in recent years, bottom-freeze refrigerators having a dispenser for dispensing ice disposed inside a refrigeration compartment door on an upper side of the refrigerator have been produced. In this case, an ice-making device for producing ice may be provided in the refrigeration compartment door or the interior of the refrigeration compartment.

In the dispenser, discharge ports for discharging ice and water, and levers for opening and closing the discharge ports are separately provided in a discharge space. The ice and the water may be discharged by operating the levers provided on the lower side of the respective discharge ports.

Such levers are typically manufactured by independently manufacturing a molding which forms an overall shell of the lever, and using a film to cover the molding and present a specific color or texture. For example, the film may be fixed or applied to an outer surface of the molding using double-side tape or by bending, shaping, or sealing an edge of the film, for example.

However, these methods for manufacturing a refrigerator dispenser lever include independently manufacturing individual components and combining the individual components together in a post-process. This post-process assembly time increases the overall manufacturing time of the lever. When the individual components are matched and assembled with one another, there is a risk of manufacturing differences or defects between individual components, thereby reducing the quality and/or appearance of the lever, and destroying a sense of unity between the components.

### SUMMARY

Embodiments of the present disclosure provide refrigerator dispenser lever and a method for manufacturing the same, capable of-reducing post-process activity required for the assembly of components, enhancing a sense of unity between components, and improving the quality and/or appearance of the lever by combining individual components during manufacturing using a single injection molding process.

According to one embodiment, a method for manufacturing a refrigerator dispenser lever is disclosed, including forming an inlay film into a predetermined shape, inserting the inlay film at one side of a mold, injecting a resin into the mold so that the resin is cured to form a molding, combining the molding and the inlay film using injection molding, where the molding and the inlay film are formed into a single object, and separating the mold to remove the object.

According to another embodiment, a refrigerator dispenser lever is disclosed, including an inlay film disposed on an outer surface of the lever, where the inlay film has a predetermined shape, and a molding that is disposed inside the inlay film, where the molding is combined with the inlay film using an injection molding process.

According to a third embodiment, a refrigerator dispenser lever is disclosed, including an inlay film having a predetermined shape disposed on an outer surface of the lever, and a molding disposed inside the inlay film and integrally formed with the inlay film using an injection molding process, where a predetermined pattern is integrally formed on a surface of the inlay film.

### BRIEF DESCRIPTION OF THE DRAWINGS

FIG. 1 is a perspective view illustrating an exemplary ref orator including an exemplary refrigerator dispenser lever according to one embodiment of the present disclosure.

FIGS. 2A, 2B, 2C and 2D are process diagrams depicting exemplary inlay film processing steps of a method for manufacturing a refrigerator dispenser lever according to one embodiment of the present disclosure.

FIGS. 3A, 3B, 3C and 3D are process diagrams depicting exemplary methods for manufacturing a refrigerator dispenser lever according to one embodiment of the present disclosure.

FIGS. 4 and 5 are perspective views illustrating an exemplary one-piece-molded component of a refrigerator dispenser lever manufactured by the exemplary method illustrated in FIGS. 3A to 3D, according to one embodiment of the present disclosure.

FIG. 6 is a flowchart depicting an exemplary sequence of steps for performing a method of manufacturing a refrigerator dispenser lever according to one embodiment of the present disclosure.

### DETAILED DESCRIPTION

In the following detailed description, reference is made to the accompanying drawings, which form a part of the description herein. The illustrative embodiments described in the detailed description, drawings, and claims are not meant to be limiting. Other embodiments may be utilized, and other changes may be made, without departing from the spirit or scope of the subject matter presented here.

One or more exemplary embodiments the present disclosure will be described more fully hereinafter with reference to the accompanying drawings, in which one or more exemplary embodiments of the disclosure can be easily ascertained by those skilled in the art. As those skilled in the art will realize, the described exemplary embodiments may be modified in various different ways, all without departing from the spirit or scope of the present disclosure, which is not limited to the exemplary embodiments described herein.

It is noted that the drawings are schematic and are not necessarily dimensionally illustrated. Relative sizes and proportions of parts in the drawings may be exaggerated or reduced in size, and a predetermined size is merely exemplary and not limiting. The same reference numerals designate the same structures, elements, or parts illustrated in two or more drawings in order to exhibit similar characteristics.

The exemplary drawings of the present disclosure illustrate ideal exemplary embodiments of the present disclosure in more detail. As a result, various modifications of the drawings are expected. Accordingly, the exemplary embodiments are not limited to a specific form of the illustrated region, and for example, include a modification of a form by manufacturing.

Embodiments of the present disclosure will now be described in detail with reference to the accompanying drawings.

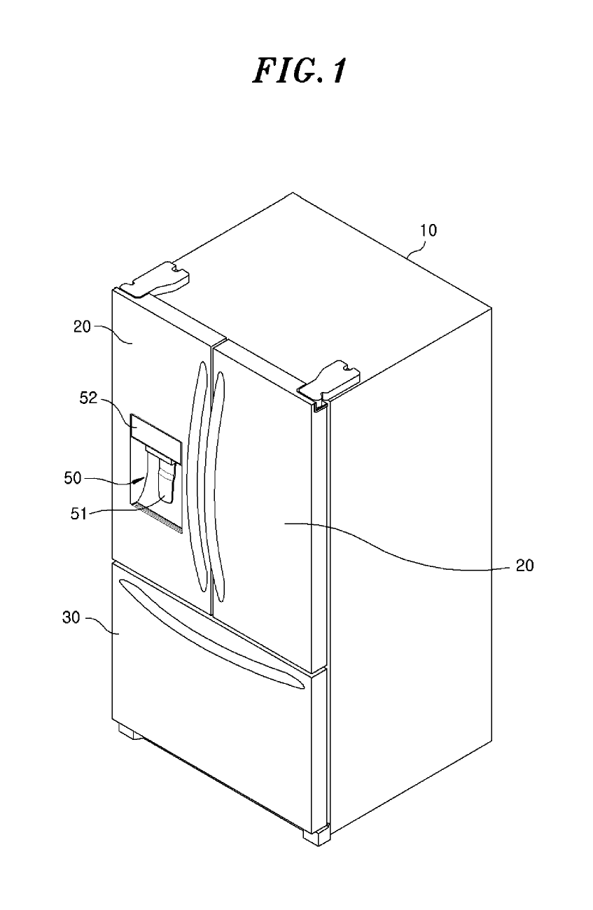

FIG. 1 is a perspective view illustrating an exemplary refrigerator including a refrigerator dispenser lever according to one embodiment of the present disclosure.

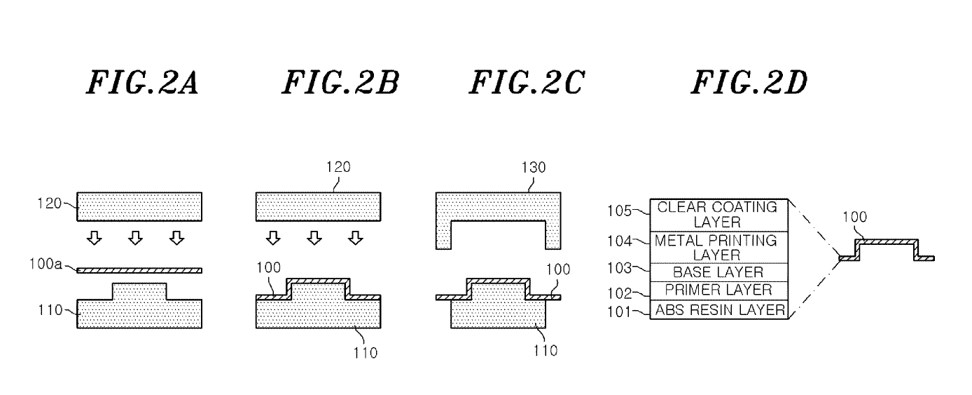

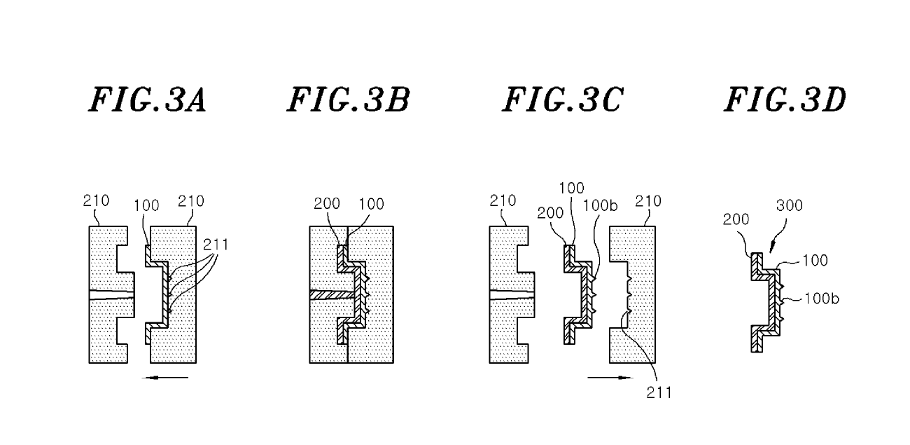

FIGS. 2A to 2D are diagrams illustrating exemplary inlay film processing steps of a method for manufacturing a refrigerator dispenser lever according to one embodiment of the present disclosure. FIGS. 3A to 3D are process diagrams illustrating an exemplary method for manufacturing a refrigerator dispenser lever according to one embodiment of the present disclosure.

Referring to FIGS. 1 to 3D, an exemplary method for manufacturing a refrigerator dispenser lever according to one embodiment of the present disclosure may include an inlay film processing step, an inlay film disposing step, a one-piece injection molding step, and a removal step.

The method described herein may be applicable to different kinds of refrigerators provided with a dispenser regardless of the type or shape of the refrigerator. For the sake of convenience and clarity, a bottom-freeze-type refrigerator will be illustrated and described below; however, the present disclosure is not limited thereto.

As illustrated in FIG. 1, a refrigerator main body 10 of refrigerator 5 has a three-dimensional rectangular shape, and the front surface thereof may be selectively opened and closed. A storage space for storing food is included inside the refrigerator main body 10.

The storage space of the refrigerator main body 10 may be divided into a refrigeration compartment and a freezing compartment, one above the other. The flow rate of cold air supplied to the refrigeration compartment and the freezing compartment is regulated so that the refrigeration compartment and the freezing compartment can be maintained at temperatures suitable for refrigerating and freezing food, respectively.

The open front surface of the refrigerator main body 10 may be selectively opened and closed by doors. The doors are configured to selectively open and close the refrigeration compartment and the freezing compartment. Rotary doors 20, which are opened and closed using rotational movement, may be mounted to the upper portion of the refrigerator main body 10. A Freezer drawer 30 may be mounted to the lower portion of the refrigerator main body 10 and may be selectively pulled out or inserted using a sliding motion.

A dispenser 50 may be provided at one side of a door (e.g., one of the rotary doors 20). The dispenser 50 is configured to enable a user to dispense water purified within the refrigerator main body 10 or ice produced within the refrigerator main body 10 from outside the refrigerator. The dispenser 50 is partially recessed within the outer surface of the door.

An activation lever 51 is provided inside the dispenser 50 so that a user can dispense purified water or ice by operating the activation lever 51. A tray or container for holding water or ice may be disposed along a lower portion of the dispenser 50.

A display unit 52 displays an operation state of the dispenser 50 or an overall operation state of the refrigerator 5, and may be disposed along a side of the dispenser 50.

The method for manufacturing a refrigerator dispenser lever will now be described with reference to FIGS. 2A to 3D.

The embodiments that follow are directed to a method for manufacturing a lever for a refrigerator dispenser, and to a lever for a refrigerator dispenser manufactured using the method. As illustrated in FIGS. 2A to 2D, an inlay film processing step is used to form an inlay film 100 having a predetermined shape. The predetermined shape corresponds to a shape of the activation lever 51 to be manufactured.

Specifically, at the inlay film processing step, a vacuum forming machine 110 having a shape corresponding to the shape of the activation lever 51 is used, and a film raw material 100a is placed on the vacuum forming machine 110 (FIG. 2A). When the film raw material 100a is heated by a heater unit 120, the film raw material 100a is shaped into a form that corresponds to the shape of the vacuum forming machine 110, and an inlay film 100 having the predetermined shape is created (FIG. 23). The edge of the inlay film 100 Is punched out and removed using a cutting or hole punching machine 130 in order to cut the inlay film 100 into a size suitable for the activation lever 51 (FIG. 2C). In this way, an inlay film 100 having a desired shape is manufactured (FIG. 2D). FIG. 2D illustrates the discrete layers 101-105 of inlay film 100.

With regard to FIG. 2D, the inlay film 100 may include an acrylonitrile-butadiene-styrene (ABS) resin layer 101, a primer layer 102, a base layer 103, a metal printing layer 104, and a clear coat layer 105, where the layers 101-105 are laminated one above another.

The primer layer 102 is laminated on the ABS resin layer 101 and serves as an adhesive to prevent other layers from being removed or separated. The base layer 103 is laminated on the primer layer 102 and may be made of an opaque or translucent material, for example. The metal printing layer 104 is laminated on the base layer 103 and printed on the base layer 103 to provide a metallic texture or appearance. For example, the metal printing layer 104 may include stainless steel printed on the base layer 103 to provide a stainless texture or appearance and improve the outward appearance of the lever. The clear coat layer 105 is laminated on the metal printing layer 104 and includes a transparent material capable of protecting the metal printing layer 104 against damage.

After the inlay film 100 is processed in this way, the inlay film disposing step may be performed. The inlay film disposing step may include a step in which the inlay film 100 is inserted into one side of a mold 210 as illustrated in FIG. 3A.

In this way, a predetermined pattern may be formed at one side of the mold 210 on which the inlay film 100 is disposed. This pattern is reproduced on the inlay film 100 disposed on an outer surface of the final article of the injection-molded process. Instead of attaching a separate film to the inlay film 100 or forming a printing layer on the inlay film 100, the pattern is formed on one side of the mold 210. Thus, when the inlay film 100 makes contact with the side of the mold 210 and is heated, the ABS resin layer 101 of the inlay film 100 is melted and introduced into a pattern groove or grooves 211 of the mold 210, where the pattern of the mold 210 is directly transferred to the inlay film 100 (pattern 100b). The pattern to be applied to the refrigerator dispenser lever may include, for example, letters or symbols that represent water and ice.

After the inlay film disposing step is completed, the one-piece injection molding step may be performed.

At the one-piece injection molding step, as illustrated in FIG. 3B, a raw resin material of a molding 200 may be injected into the mold 210 in which the inlay film 100 is disposed. The injected resin makes contact with the inlay film 100 disposed within the mold 210. As the resin is cured to form the molding 200, the inlay film 100 may be combined and injection-molded as a unitary article.

The inlay film 100 disposed within the mold 210 and the molding 200 formed by the solidification of the resin are combined to form a unitary article, and an injection-molded article having a single body (hereinafter referred to as a “unitary article 300”) is produced.

As illustrated in FIG. 3C, at the removal step, the mold 210 is separated and/or released in order to remove the unitary article 300. In this way, the unitary article 300 illustrated in FIG. 3D is manufactured.

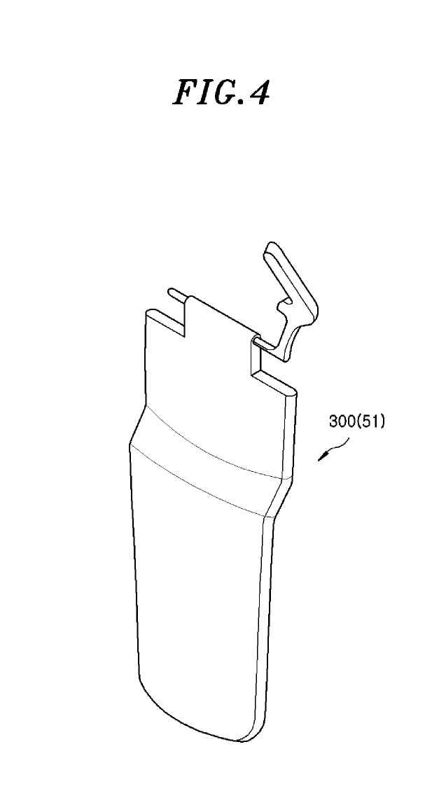

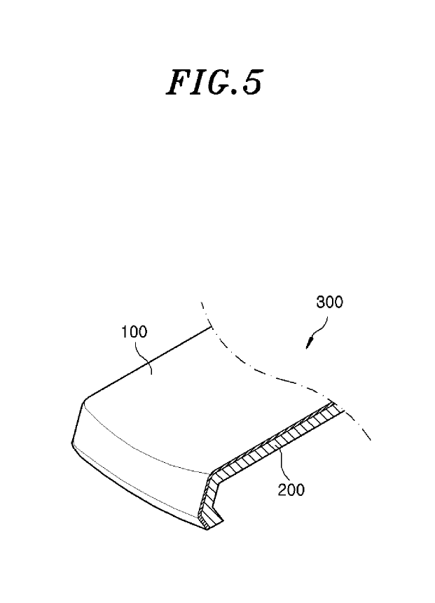

Descriptions will now be made with reference to FIGS. 4 and 5. FIGS. 4 and 5 are perspective views illustrating an exemplary unitary article of the refrigerator dispenser lever manufactured by the method illustrated in FIGS. 3A to 3D.

In FIG. 3D, the exemplary unitary article 300 is illustrated in order to easily describe the overall manufacturing process according to the present embodiment. Alternatively, the unitary article 300 used as the refrigerator dispenser lever may have a shape as illustrated in FIGS. 4 and 5. The inlay film 100 exists on the outer surface of the unitary article 300. The molding 200 formed by curing the resin injected into the mold 210 is disposed at the inner side of the inlay film 100.

The refrigerator dispenser lever 51 (unitary article 300) manufactured by the manufacturing method described above may include the inlay film 100 and the molding 200. The inlay film 100 is disposed on the outer surface of the lever 51. The molding 200 is disposed at the inner side of the inlay film 100 and is integrally combined with the inlay film 100 using an injection molding process. The molding 200 is formed as the resin injected into the mold 210 during the injection molding process is cured.

Furthermore, a predetermined pattern to be applied to the refrigerator dispenser lever may be integrally formed on the surface of the inlay film 100.

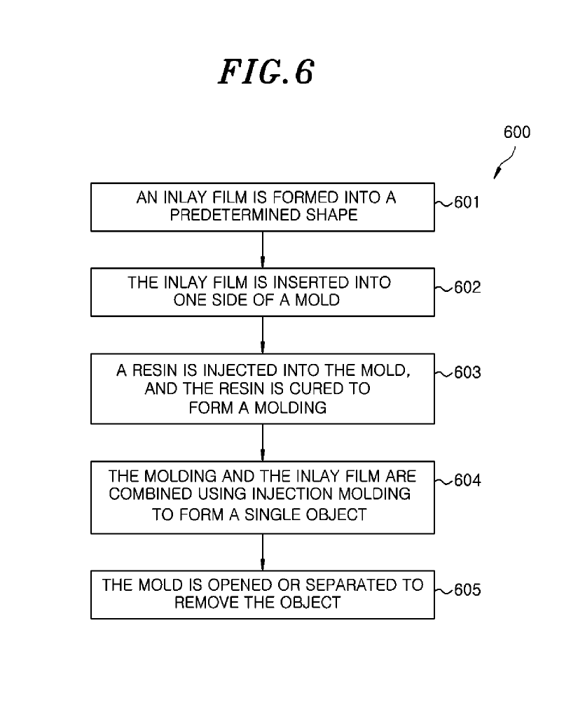

With regard to FIG. 6, an exemplary sequence of steps for performing a method 600 of manufacturing a refrigerator dispenser lever is depicted according to one embodiment of the present disclosure. At step 601, an inlay film is formed into a predetermined shape. At step 602, the inlay film is inserted into one side of a mold. At step 603, a resin is injected into the mold, and the resin is cured to form a molding. At step 604, the molding and the inlay film are combined using injection molding, where the molding and the inlay film are formed into a single object. At step 605, the mold is opened or separated to remove the object.

Although exemplary embodiments of the present disclosure are described above with reference to the accompanying drawings, those skilled in the art will understand that the present disclosure may be implemented in various ways without changing the necessary features or the spirit of the present disclosure.

Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is:

1. A method for manufacturing a refrigerator dispenser lever, comprising:
forming an inlay film into a predetermined shape;
inserting the inlay film into one side of a mold;
injecting a resin into the mold to form a molding;
combining the molding and the inlay film using injection molding, wherein the molding and the inlay film are formed into a single object; and
separating the mold to remove the object.

2. The method of claim 1, wherein the forming an inlay film into a predetermined shape comprises:
acing a raw film material on a vacuum forming machine having a predetermined shape;
heating the raw film material to create the inlay film having a predetermined shape; and
removing an edge of the inlay film.

3. The method of claim 1, wherein the inlay film comprises:
an ABS resin layer;
an adhesive primer layer laminated on the ABS resin layer;
a base layer laminated on the adhesive primer layer and comprising an opaque or translucent material;
a metal printing layer laminated and printed on the base layer, wherein the metal printing layer comprises a metallic texture; and
a clear coat layer laminated on the metal printing layer, wherein the clear coat layer comprises a transparent material for protecting the metal printing layer.

4. The method of claim 1, further comprising forming a pattern on one side of the mold on which the inlay film is disposed, wherein the pattern is reproduced on a surface of the inlay film.

5. A refrigerator dispenser lever apparatus, the lever apparatus comprising:
an inlay film disposed on an outer surface of a lever, wherein the inlay film has a predetermined shape; and
a molding disposed at an inner side of the inlay film, wherein the molding is combined with the inlay film using an injection molding process.

6. The lever apparatus of claim 5, wherein the inlay film comprises:
an ABS resin layer;
an adhesive primer layer laminated on the ABS resin layer;
a base layer laminated on the adhesive primer layer;
a metal printing layer laminated on the base layer and printed on the base layer; and
a clear coat layer laminated on the metal printing layer, wherein the clear coat layer comprises a transparent material for protecting the metal printing layer.

7. The lever apparatus of claim 6, wherein a predetermined pattern is formed on a surface of the inlay film.

8. The lever apparatus of claim 6, wherein the base layer comprises a translucent material.

9. The lever apparatus of claim 6, wherein the metal printing layer comprises a metallic texture.

10. The lever apparatus of claim 6, wherein the metal printing layer appears substantially metallic.

11. The lever apparatus of claim 6, wherein the metal printing layer comprises a stainless steel texture.

12. The lever apparatus of claim 6, wherein the metal printing layer appears substantially similar to stainless steel.

13. A refrigerator dispenser lever apparatus comprising:
an inlay film having a predetermined shape disposed on an outer surface of a lever; and
a molding disposed at an inner side of the inlay film and integrally formed with the inlay film using an infection molding process,
wherein a predetermined pattern is integrally formed on a surface of the inlay film.

14. The lever apparatus of claim 13, wherein the inlay film comprises:
an ABS resin layer;
an adhesive primer layer laminated on the ABS resin layer;
a base layer laminated on the adhesive primer layer;
a metal printing layer laminated on the base layer and printed on the base layer; and
a clear coat layer laminated on the metal printing layer, wherein the clear coat layer comprises a transparent material for protecting the metal printing layer.

15. The lever apparatus of claim 14, wherein the base layer comprises a translucent material.

16. The lever apparatus of claim 14, wherein the metal printing layer comprises a metallic texture.

17. The lever apparatus of claim 14, wherein the metal printing layer appears substantially metallic.

18. The lever apparatus of claim 14, wherein the metal printing layer comprises a stainless steel texture.

19. The lever apparatus of claim 14, wherein the metal printing layer appears substantially similar to stainless steel.
